(19) United States
(12) Patent Application Publication
(10) Pub. No.: US 2020/0300175 A1
(43) Pub. Date: Sep. 24, 2020

(54) GEARBOX FOR A TURBOMACHINE WITH ALTERNATINGLY SPACED ROTOR BLADES

(71) Applicant: GE Avio S.r.l., Rivalta di Torino (IT)

(72) Inventors: Giulio Zagato, Moncalieri (IT); Saypen Baraggia Au Yeung, Valenza (IT); Giuseppe Casamirra, Turin (IT)

(21) Appl. No.: 16/811,582

(22) Filed: Mar. 6, 2020

(30) Foreign Application Priority Data
Mar. 19, 2019 (IT) 102019000003991

(51) Int. Cl. F02C 7/36; F16H 1/22

(52) U.S. Cl. CPC F02C 7/36; F05D 2220/32; F16H 1/222

(57) ABSTRACT

In one exemplary embodiment of the present disclosure a gas turbine engine defining a radial direction and an axial direction is provided. The gas turbine engine includes a stationary frame, a compressor and a turbine, the compressor or the turbine including a first plurality of rotor blades and a second plurality of rotor blades, the first plurality of rotor blades and second plurality of rotor blades alternatingly spaced along the axial direction and rotatable with one another; and a gearbox including a first gear coupled to the first plurality of rotor blades, a second gear coupled to the second plurality of rotor blades, and an intermediate gear positioned between the first gear and the second gear and coupled to the stationary frame, the intermediate gear defining an axis of rotation, the axis of rotation defining an angle with the radial direction less than about 75 degrees.

### PRIORITY INFORMATION

The present application claims priority to Italian Patent Application Number 102019000003991 filed on 19 Mar. 2019.

### FIELD

The present subject matter relates generally to a turbomachine, and more particularly, to a gearbox for a turbomachine having alternatingly spaced rotor blades.

### BACKGROUND

Gas turbine engines generally include a turbine section downstream of a combustion section that is rotatable with a compressor section to rotate and operate the gas turbine engine to generate power, such as propulsive thrust. General gas turbine engine design criteria often include conflicting criteria that must be balanced or compromised, including increasing fuel efficiency, operational efficiency, and/or power output while maintaining or reducing weight, part count, and/or packaging (i.e. axial and/or radial dimensions of the engine).

Within at least certain gas turbine engines, the turbine section may include interdigitated rotors (i.e., successive rows or stages of rotating airfoils or blades). For example, a turbine section may include a turbine having a first plurality of low speed turbine rotor blades and a second plurality of high speed turbine rotor blades rotatable with one another through a reversing gearbox. The first plurality of low speed turbine rotor blades may be interdigitated with the second plurality of high speed turbine rotor blades. Such a configuration may result in a more efficient turbine.

However, several problems may arise with such a configuration relating to clearance issues between the first and second pluralities of rotor blades and packaging of the gearbox inward of the turbine. Accordingly, an improved turbine with interdigitated turbine rotor blades would be useful.

### BRIEF DESCRIPTION

Aspects and advantages of the invention will be set forth in part in the following description, or may be obvious from the description, or may be learned through practice of the invention.

In one exemplary embodiment of the present disclosure a gas turbine engine defining a radial direction and an axial direction is provided. The gas turbine engine includes a stationary frame, a compressor and a turbine, the compressor or the turbine including a first plurality of rotor blades and a second plurality of rotor blades, the first plurality of rotor blades and second plurality of rotor blades alternatingly spaced along the axial direction and rotatable with one another; and a gearbox including a first gear coupled to the first plurality of rotor blades, a second gear coupled to the second plurality of rotor blades, and an intermediate gear positioned between the first gear and the second gear and coupled to the stationary frame, the intermediate gear defining an axis of rotation, the axis of rotation defining an angle with the radial direction less than about 75 degrees.

In certain exemplary embodiments the angle the axis of rotation defines with the radial direction is less than about 30 degrees.

In certain exemplary embodiments the angle the axis of rotation defines with the radial direction is less than about 15 degrees.

In certain exemplary embodiments the angle the axis of rotation defines with the radial direction is about zero degrees.

In certain exemplary embodiments the intermediate gear is a first intermediate gear of a plurality of intermediate gears spaced along a circumferential direction of the gas turbine engine within the gearbox.

In certain exemplary embodiments the intermediate gear defines a forward end and an aft end, wherein the first gear meshes with the intermediate gear at the forward end and wherein the second gear meshes with the intermediate gear at the aft end.

For example, in certain exemplary embodiments the first gear and the intermediate gear together define a first intersection line, wherein the second gear and the intermediate gear together define a second intersection line, wherein the first intersection line defines a first intersection angle less than about 75 degrees with the radial direction, and wherein the second intersection line defines a second intersection angle less than about 75 degrees with the radial direction.

For example, in certain exemplary embodiments the first intersection angle is less than about 30 degrees with the radial direction, and wherein the second intersection angle is less than about 30 degrees with the radial direction.

For example, in certain exemplary embodiments the first intersection angle, the second intersection angle, and the angle the axis of rotation defines with the radial direction are each equal to about zero degrees.

For example, in certain exemplary embodiments the first intersection angle and the second intersection angle are each greater than the angle the axis of rotation defines with the radial direction.

In certain exemplary embodiments the turbine includes the first plurality of rotor blades and the second plurality of rotor blades, and wherein the stationary frame is a turbine frame.

For example, in certain exemplary embodiments the turbine is a low pressure turbine.

In certain exemplary embodiments the gas turbine engine in an aeronautical gas turbine engine.

In certain exemplary embodiments the intermediate gear is a compound gear including an outer gear and an inner gear rotatable with one another, wherein one of the first gear or second gear meshes with the outer gear of the intermediate gear, and wherein the other of the first gear or second gear meshes with the inner gear of the intermediate gear.

For example, in certain exemplary embodiments the outer gear defines a first diameter, wherein the inner gear defines an second diameter, wherein the first diameter is not equal to the second diameter.

A gearbox for a gas turbine engine defining a radial direction and an axial direction, the gas turbine engine including a stationary frame, a compressor, and a turbine, the compressor or the turbine comprising a first plurality of rotor blades and a second plurality of rotor blades alternatingly spaced, the gearbox including a first gear configured to be coupled to the first plurality of rotor blades of the gas turbine engine; a second gear configured to be coupled to the second plurality of rotor blades of the gas turbine engine; and an intermediate gear configured to be coupled to the stationary frame of the gas turbine engine, the intermediate gear defining a forward end and an aft end, the first gear meshing with the intermediate gear at the forward end, the second gear meshing with the intermediate gear at the aft end.

In certain exemplary embodiments the intermediate gear further defines an axis of rotation defining an angle with the radial direction less than about 75 degrees.

For example, in certain exemplary embodiments the angle the axis of rotation defines with the radial direction is less than about 15 degrees.

In certain exemplary embodiments the first gear and the intermediate gear together define a first intersection line, wherein the second gear and the intermediate gear together define a second intersection line, wherein the first intersection line defines a first intersection angle less than about 75 degrees with the radial direction, and wherein the second intersection line defines a second intersection angle less than about 75 degrees with the radial direction

In certain exemplary embodiments the intermediate gear is a compound gear including an outer gear and an inner gear rotatable with one another, wherein one of the first gear or second gear meshes with the outer gear of the intermediate gear, and wherein the other of the first gear or second gear meshes with the inner gear of the intermediate gear.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross sectional view of an exemplary gas turbine engine incorporating an exemplary embodiment of a turbine section according to an aspect of the present disclosure;

FIG. 2 is a schematic, cross sectional view of a turbine section in accordance with an exemplary aspect of the present disclosure;

FIG. 3 is a cross sectional view depicting exemplary blade pitch angles of a turbine of a turbine section in accordance with an exemplary embodiment of the present disclosure;

FIG. 4 is a perspective, cross-sectional view of a gearbox in accordance with an exemplary embodiment of the present disclosure.

FIG. 5 is a schematic, cross sectional view of a turbine section in accordance with another exemplary aspect of the present disclosure;

FIG. 6 is a schematic, cross sectional view of a turbine section in accordance with yet another exemplary aspect of the present disclosure;

FIG. 7 is a schematic, cross sectional view of a turbine section in accordance with still another exemplary aspect of the present disclosure; and

FIG. 8 is a schematic, cross sectional view of a turbine section in accordance with yet another exemplary aspect of the present disclosure.

Repeat use of reference characters in the present specification and drawings is intended to represent the same or analogous features or elements of the present invention.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The terms “low speed” and “high-speed” refer to relative speeds, such as relative rotational speeds, of two components during operations of the turbomachine, and do not imply or require any minimum or maximum absolute speeds.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

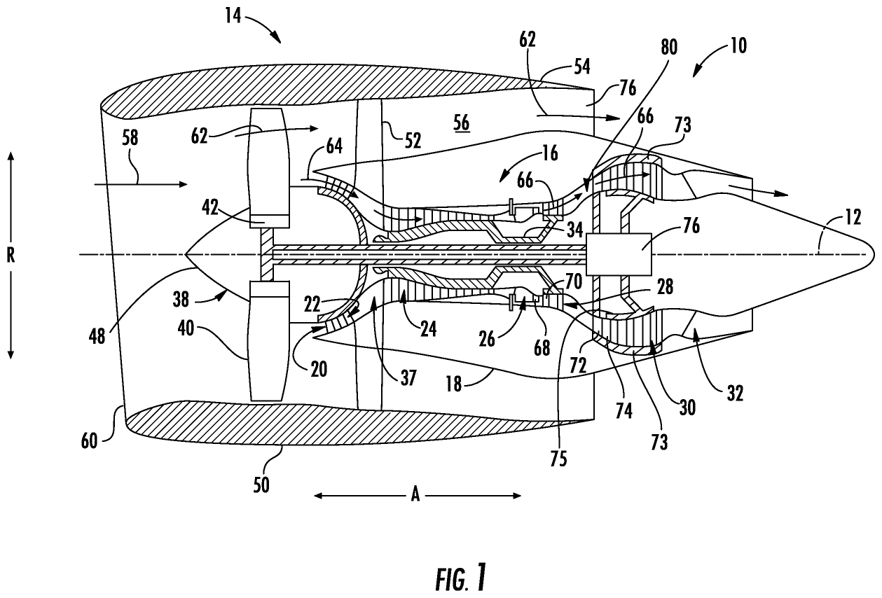

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference), a radial direction R, and a circumferential direction (i.e., a direction extending about the axial direction A; not depicted). In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. The compressor section, combustion section 26, and turbine section together define a core air flowpath 37 extending from the annular inlet 20 through the LP compressor 22, HP compressor 24, combustion section 26, HP turbine section 28, LP turbine section 30 and jet nozzle exhaust section 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. The fan blades 40 and disk 42 are together rotatable about the longitudinal axis 12 by LP shaft 36.

Referring still to the exemplary embodiment of FIG. 1, the disk 42 is covered by rotatable spinner cone 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that for the embodiment depicted, the nacelle 50 is supported relative to the core turbine engine 16 by a plurality of circumferentially-spaced outlet guide vanes 52. Moreover, a downstream section 54 of the nacelle 50 extends over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to an inner casing (not shown) and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of a first plurality of LP turbine rotor blades 72 that are coupled to an outer drum 73, and a second plurality of LP turbine rotor blades 74 that are coupled to an inner drum 75. The first plurality of LP turbine rotor blades 72 and second plurality of LP turbine rotor blades 74 are alternatingly spaced and rotatable with one another through a gearbox 76 to together drive the LP shaft or spool 36, thus causing the LP shaft or spool 36 to rotate. Such thereby supports operation of the LP compressor 22 and/or rotation of the fan 38.

As will explained in greater detail, below, the gearbox 76 is configured to occupy a smaller radial footprint to, e.g., allow for a smaller diameter turbine, such as a smaller diameter LP turbine 30.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 78 of the turbofan 10, also providing propulsive thrust. The HP turbine 28, the LP turbine 30, and the jet exhaust nozzle section 32 at least partially define a hot gas path 80 for routing the combustion gases 66 through the core turbine engine 16.

It should be appreciated, however, that the exemplary turbofan engine 10 depicted in FIG. 1 is by way of example only, and that in other exemplary embodiments, the turbofan engine 10 may have any other suitable configuration. For example, in other exemplary embodiments, the turbofan engine 10 may instead be configured as any other suitable turbomachine including, e.g., any other suitable number of shafts or spools, and excluding, e.g., the fan 38 and/or including, e.g., a gearbox between the fan 38 and the LP shaft or spool 36, a variable pitch fan 38, etc. Accordingly, it will be appreciated that in other exemplary embodiments, the turbofan engine 10 may instead be configured as, e.g., a turbojet engine, a turboshaft engine, a turboprop engine, etc., and further may be configured as an aeroderivative gas turbine engine or industrial gas turbine engine.

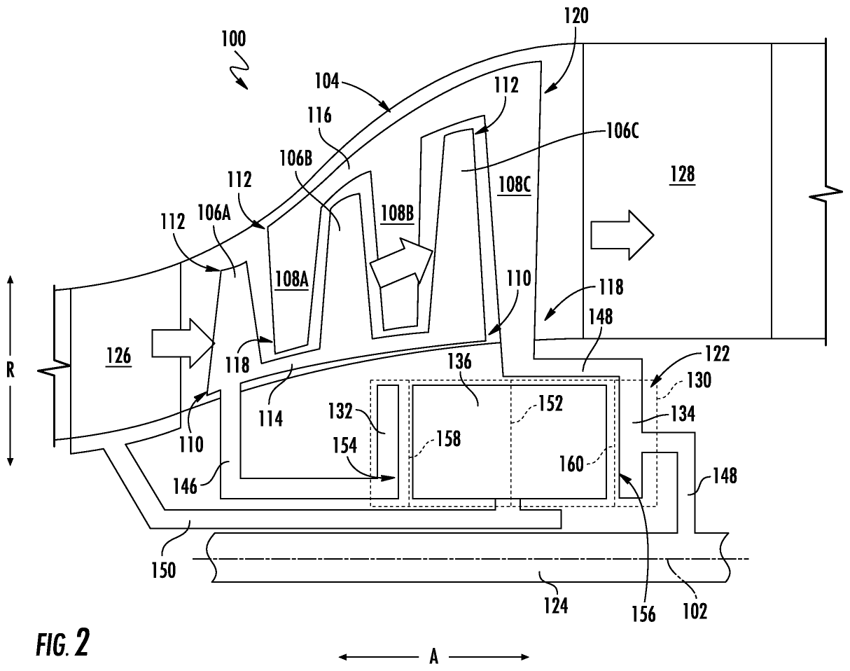

Referring now to FIG. 2, a schematic, side, cross-sectional view is provided of a turbine section 100 of a gas turbine engine in accordance with an exemplary embodiment of the present disclosure. The exemplary turbine section 100 depicted in FIG. 2 may be incorporated into, e.g., the exemplary turbofan engine 10 described above with reference to FIG. 1. However, in other exemplary embodiments, the turbine section 100 may be integrated into any other suitable machine utilizing a turbine.

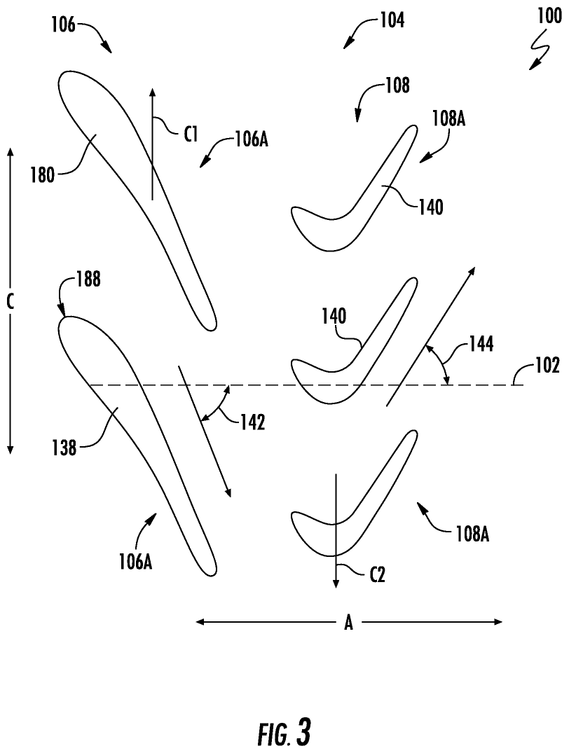

Accordingly, it will be appreciated that the gas turbine engine within which the turbine section 100 is included generally defines a radial direction R, an axial direction A, a circumferential direction C extending about the axial direction A (see FIG. 3), and a longitudinal centerline 102. Further, the turbine section 100 includes a turbine 104. For example, in certain embodiments, the turbine 104 may be a low pressure turbine (such as the exemplary low pressure turbine 30 of FIG. 1), or alternatively may be any other turbine (such as, a high pressure turbine, an intermediate turbine, a dual use turbine functioning as part of a high pressure turbine and/or a low pressure turbine, etc.).

Moreover, for the exemplary embodiment depicted, the turbine 104 includes a first plurality of rotor blades, or rather a first plurality of turbine rotor blades 106, and a second plurality of rotor blades, or rather a second plurality of turbine rotor blades 108. As will be discussed in greater detail below, the first plurality of turbine rotor blades 106 and second plurality of turbine rotor blades 108 are alternatingly spaced along the axial direction A.

Referring first to the first plurality of turbine rotor blades 106, each of the first plurality of turbine rotor blades 106 extends generally along the radial direction R between a radially inner end 110 and a radially outer end 112. Additionally, the first plurality of turbine rotor blades 106 includes a first turbine rotor blade 106A, a second turbine rotor blade 106B, and a third turbine rotor blade 106C, each spaced apart from one another generally along the axial direction A. At least two of the first plurality of turbine rotor blades 106 are spaced from one another along the axial direction A and coupled to one another at the respective radially inner ends 110. More specifically, for the embodiment depicted, each of the first turbine rotor blade 106A, the second turbine rotor blade 106B, and the third turbine rotor blade 106C are coupled to one another through their respective radially inner ends 110. More specifically, still, each of the first turbine rotor blade 106A, the second turbine rotor blade 106B, and the third turbine rotor blade 106C of the first plurality of turbine rotor blades 106 are coupled at their respective radially inner ends 110 through an inner drum 114.

Further, the second plurality of turbine rotor blades 108, each also extend generally along the radial direction R between a radially inner end 118 and a radially outer end 120. Additionally, for the embodiment depicted, the second plurality of turbine rotor blades 108 includes a first turbine rotor blade 108A, a second turbine rotor blade 108B, and a third turbine rotor blade 108C, each spaced apart from another generally along the axial direction A. For the embodiment depicted, at least two of the second plurality of turbine rotor blades 108 are spaced from one another along the axial direction A and coupled to one another at the respective radially outer ends 120. More specifically, for the embodiment depicted, each of the first turbine rotor blade 108A, the second turbine rotor blade 108B, and the third turbine rotor blade 108C of the second plurality of turbine rotor blades 108 are mechanically coupled to one another through their respective radially outer ends 120. More specifically, still, each of the first turbine rotor blade 108A, the second turbine rotor blade 108B, and the third turbine rotor blade 108C of the second plurality of turbine rotor blades 108 are coupled at their respective radially outer ends 120 through an outer drum 116.

It should be appreciated, however, that in other exemplary embodiments, the first plurality of turbine rotor blades 106 and/or the second plurality of turbine rotor blades 108 may be coupled together in any other suitable manner, and that as used herein, “coupled at the radially inner ends” and “coupled at the radially outer ends” refers generally to any direct or indirect coupling means or mechanism to connect the respective components. For example, in certain exemplary embodiments, the second plurality of turbine rotor blades 108 may include multiple stages of rotors (not shown) spaced along the axial direction A, with the first turbine rotor blade 108A, the second turbine rotor blade 108B, and the third turbine rotor blade 108C coupled to the respective stages of rotors at the respectively radially inner ends 118 through, e.g. dovetail base portions. The respective stages of rotors may, in turn, be coupled together to therefore “couple the second plurality of turbine rotor blades 108 at their respective radially inner ends 118.”

Referring still to the embodiment depicted in FIG. 2, as stated, the first plurality of turbine rotor blades 106 and the second plurality of turbine rotor blades 108 are alternatingly spaced along the axial direction A. As used herein, the term “alternatingly spaced along the axial direction A” refers to the second plurality of turbine rotor blades 108 including at least one turbine rotor blade positioned along the axial direction A between two axially spaced turbine rotor blades of the first plurality of turbine rotor blades 106. For example, for the embodiment depicted, alternatingly spaced along the axial direction A refers to the second plurality of turbine rotor blades 108 including at least one turbine rotor blade positioned between the first and second turbine rotor blades 106A, 106B of the first plurality of turbine rotor blades 106 along the axial direction A, or between the second and third turbine rotor blades 106B, 106C of the first plurality of turbine rotor blades 106 along the axial direction A. More specifically, for the embodiment depicted, the first turbine rotor blade 106A of the first plurality of turbine rotor blades 106 is positioned forward of the first turbine rotor blade 108A of the second plurality of turbine rotor blades 108; the second turbine rotor blade 106B of the first plurality of turbine rotor blades 106 is positioned between the first and second turbine rotor blades 108A, 108B of the second plurality of turbine rotor blades 108; and the third turbine rotor blade 106C of the first plurality of turbine rotor blades 106 is positioned between the second and third turbine rotor blades 108B, 108C of the second plurality of turbine rotor blades 108.

Notably, however, in other exemplary embodiments, the first plurality of turbine rotor blades 106 may have any other suitable configuration and/or the second plurality of turbine rotor blades 108 may have any other suitable configuration. For example, it will be appreciated that for the embodiments described herein, the first turbine rotor blade 106A, second turbine rotor blade 106B, and third turbine rotor blade 106C of the first plurality of turbine rotor blades 106 generally represent a first stage of turbine rotor blades, a second stage of turbine rotor blades, and a third stage of turbine rotor blades, respectively. It will similarly be appreciated that the first turbine rotor blade 108A, second turbine rotor blade 108B, and third turbine rotor blade 108C of the second plurality of turbine rotor blades 108 each also generally represent a first stage of turbine rotor blades, a second stage of turbine rotor blades, and a third stage of turbine rotor blades, respectively. In other exemplary embodiments, the first plurality of turbine rotor blades 106 and/or the second plurality of turbine rotor blades 108 may include any other suitable number of stages of turbine rotor blades, such as two stages, four stages, etc., and further that in certain exemplary embodiments, the turbine 104 may additionally include one or more stages of stator vanes.

Moreover, for the embodiment depicted, the gas turbine engine further includes a gearbox 122 and a spool 124, with the first plurality of turbine rotor blades 106 and the second plurality of turbine rotor blades 108 rotatable with one another through the gearbox 122 and drivingly coupled to the spool 124. In at least certain exemplary embodiments, the spool 124 may be configured as, e.g., the exemplary low pressure spool 36 described above with reference to FIG. 1. It should be appreciated, however, that in other exemplary embodiments, the spool 124 may be any other spool (e.g., a high pressure spool, an intermediate spool, etc.). Additionally, the exemplary turbine section 100 further includes stationary frame member, and more specifically a turbine center frame 126 and a turbine rear frame 128.

Referring particularly to the gearbox 122, it will be appreciated that the gearbox 122 generally includes a casing 130. The casing 130 is depicted in phantom in FIG. 2 for clarity. The exemplary gearbox 122 depicted further includes a first gear 132 coupled to the first plurality of turbine rotor blades 106, a second gear 134 coupled to the second plurality of turbine rotor blades 108, and an intermediate gear 136 positioned between the first gear 132 and second gear 134 and coupled to a turbine frame, or rather to the turbine center frame 126. The intermediate gear 136 is rotatably coupled to the turbine center frame 126. In such a manner, it will be appreciated that for the embodiment depicted, the intermediate gear 136 remains stationary in the circumferential direction C, such that the first plurality of turbine rotor blades 106 are configured to rotate in an opposite circumferential direction than the second plurality of turbine rotor blades 108.

More specifically, referring briefly to FIG. 3, an orientation of the first plurality of turbine rotor blades 106 and the second plurality of turbine rotor blades 108 is generally provided. As shown, the embodiment of FIG. 3 depicts a first stage of turbine rotor blades 106A of the first plurality of turbine rotor blades 106 and a first stage of turbine rotor blades 108A of the second plurality of turbine rotor blades 108. In the embodiment shown, the first plurality of turbine rotor blades 106 are configured to rotate in a first circumferential direction C1, while the second plurality of turbine rotor blades 108 are configured to rotate in a second circumferential direction C2. It should be understood that the first circumferential direction C1 and the second circumferential direction C2 as used and described herein are intended to denote directions relative to one another. Therefore, the first circumferential direction C1 may refer to a clockwise rotation (viewed from downstream looking upstream) and the second circumferential direction C2 may refer to a counter-clockwise rotation (viewed from downstream looking upstream). Alternatively, the first circumferential direction C1 may refer to a counter-clockwise rotation (viewed from downstream looking upstream) and the second circumferential direction C2 may refer to a clockwise rotation (viewed from downstream looking upstream).

Referring still to FIG. 3, it will further be appreciated that for the embodiment depicted, each turbine rotor blade 106A of the first plurality of turbine rotor blades 106 includes an airfoil 138, and similarly, each turbine rotor blade 108A of the second plurality of turbine rotor blades 108 includes an airfoil 140. The airfoils 138 each define an exit angle 142, and similarly the airfoils 140 each define an exit angle 144. Further, the airfoils 138, 140 may each further include a suction side 192 and a pressure side 194. The exit angles 142, 144 of the airfoils 138, 140, respectively, as well as the pressure and suction sides (not labeled) of such airfoils 138, 140, respectively, may cause the first plurality of turbine rotor blades 106 and second plurality of turbine rotor blades 108 to rotate in the first and second circumferential directions C1, C2, respectively. It will be appreciated, however, that in other embodiments, the airfoils 138, 140 may have any other suitable configuration.

Referring back to FIG. 2, and as previously noted, the exemplary gearbox 122 depicted generally includes the first gear 132 coupled to the first plurality of turbine rotor blades 106, the second gear 134 coupled to the second plurality of turbine rotor blades 108, and the intermediate gear 136 positioned between the first gear 132 and second gear 134 and coupled to a turbine frame, or rather to the turbine center frame 126. More specifically, the first plurality of turbine rotor blades 106 is coupled to the first gear 132 of the gearbox 122 through a first support member 146, the second plurality of turbine rotor blades 108 is coupled to the second gear 134 of the gearbox 122 through a second support member 148, and the intermediate gear 136 of the gearbox 122 is coupled to the turbine center frame through a frame member 150. Further, it will be appreciated that for the embodiment depicted, the second support member 148, the second gear 134 of the gearbox 122, or both are connected to the spool 124.

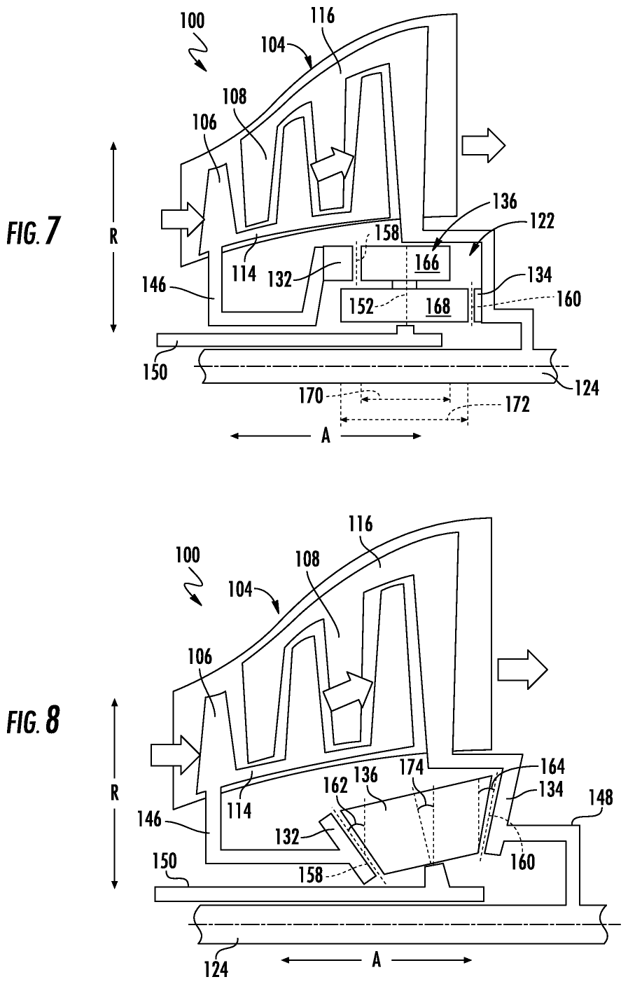

Further, the intermediate gear 136 defines an axis of rotation 152 and is rotatably coupled to the frame member 150 such that it may rotate about the axis of rotation 152. For the embodiment depicted, the axis of rotation 152 defines an angle with the radial direction R less than about seventy-five (75) degrees. More specifically, for the embodiment shown, the angle the axis of rotation 152 defines with the radial direction R is about zero (0) degrees (i.e., less than or equal to ten (10) degrees; notably, the angle is not depicted or labeled in FIG. 2 because the angle is zero degrees; cf. FIG. 8). In such a manner, it will be appreciated that the intermediate gear 136 defines a forward end 154 and an aft end 156 generally along the axial direction A of the gas turbine engine. The first gear 132 of the gearbox 122 meshes with the intermediate gear 136 at the forward end 154 and at the second gear 134 meshes with the intermediate gear 136 at the aft end 156.

Further, still, as is depicted in phantom, the first gear 132 and intermediate gear 136 together define a first intersection line 158 where the first gear 132 meshes with the intermediate gear 136. Similarly, the second gear 134 and the intermediate gear 136 together define a second intersection line 160 where the second gear 134 meshes with the intermediate gear 136. For the embodiment shown, the first intersection line 158 defines a first intersection angle 162 less than about seventy-five (75) degrees with the radial direction R (notably, the first intersection angle 162 is not depicted in FIG. 2 since the angle is equal to zero; cf. FIG. 5), and more specifically the first intersection angle 162 defined by the first intersection line 158 with the radial direction R is about zero (0) degrees. Similarly, the second intersection line 160 defines a second intersection angle 164 less than about seventy-five (75) degrees with the radial direction R (again, the second intersection angle 164 is not depicted in FIG. 2 since the angle is equal to zero; cf. FIG. 5), and more specifically, the second intersection angle 164 defined by the second intersection line 160 with the radial direction R is also about zero (0) degrees. As such, it will be appreciated that for the embodiment of FIG. 2, the first intersection angle 162, the second intersection angle 164, and the angle the axis of rotation 152 defines with the radial direction R are each equal to about zero (0) degrees.

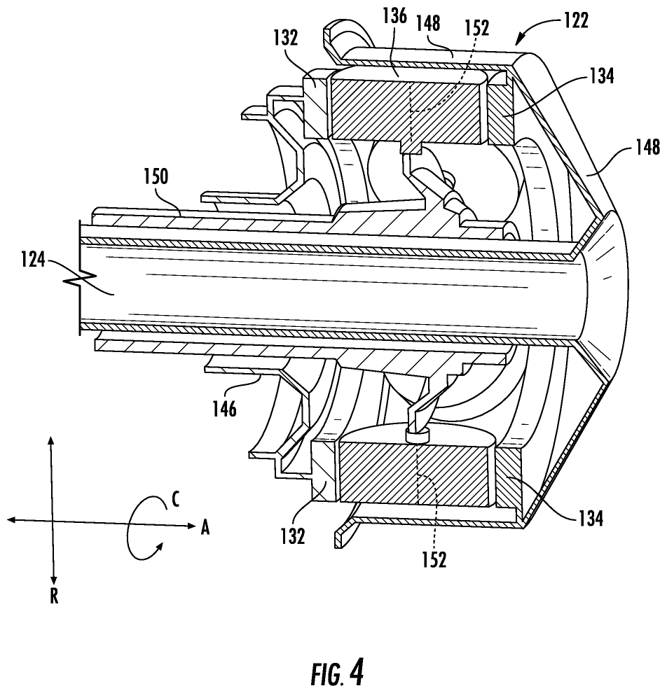

Referring now also to FIG. 4, a perspective, cross-sectional view of the exemplary gearbox 122 of FIG. 2 is depicted. As is shown, the intermediate gear 136 of the gearbox 122 is a first intermediate gear 136A of a plurality of intermediate gears 136. The plurality of intermediate gears 136 are spaced along the circumferential direction C of the gas turbine engine within the gearbox 122. Each of the plurality of intermediate gears 136 may be configured in a similar manner to the intermediate gear 136 described above with reference to FIG. 2. For example, each of the plurality of intermediate gears 136 depicted is positioned between the first gear 132 and the second gear 134, and is rotatably coupled to the frame member 150, defining an axis of rotation 152 about which it is configured to rotate. For the embodiment shown, the axis of rotation 152 of each of the plurality of intermediate gears 136 defines an angle with the radial direction R less than about seventy-five (75) degrees, and more specifically, equal to about zero (0) degrees. (Notably, the gears 132, 134, 136 are depicted without gear teeth for clarity. It will be appreciated that any suitable gear teeth configuration may be utilized.)

For the embodiment depicted, the gearbox 122 includes between two and eight intermediate gears 136, and more specifically, gearbox 122 includes six intermediate gears 136 spaced along the circumferential direction C. However, in other embodiments, the gearbox 122 may include any other suitable number of intermediate gears 136. Moreover, it will be appreciated that for the embodiment depicted, the second support member 148 extends continuously from the second plurality of turbine rotor blades 108, to the second gear 134 of the gearbox 122, and to the spool 124. It will be appreciated, however, that in other embodiments, the second support member 148, the spool 124, or both, may include one or more joints or breaks to facilitate installation of the gearbox 122. By way of example, in certain exemplary embodiments, the second support member 148 may include a joint proximate the second gear 134, proximate the spool 124, or both.

Inclusion of a gearbox 122 configured in such a manner may allow for the gearbox 122 to occupy a smaller radial space inward of the turbine 104, as compared to, e.g., a traditional planetary gearbox. Such may therefore allow for a turbine having a smaller diameter, saving weight and cost and increasing an overall efficiency.

It will be appreciated, however, that the exemplary turbine 104 and gearbox 122 depicted in FIGS. 2 and 4 are provided by way of example only. For example, in other embodiments, although not depicted, the turbine 104, the gearbox 122, or both may include one or more bearing assemblies for facilitating rotation of the various components therein.

Moreover, it will be appreciated that although the exemplary intermediate gear(s) 136 of the gearbox 122 depicted in FIGS. 2 and 4, and discussed above, are depicted as a single gear rotatable about its axis of rotation 152, in other embodiments, the intermediate gear 136, as well as the first gear 132 and second gear 134, may have any other suitable configuration.

For example, referring now briefly to FIG. 5, providing a schematic view of a turbine 104 and gearbox 122 in accordance with another exemplary embodiment of the present disclosure, the intermediate gear 136 is configured as a bevel gear. More specifically, the intermediate gear 136 defines an axis of rotation 152, a first intersection line 158 where the intermediate gear 136 meshes with first gear 132, and a second intersection line 160 where the intermediate gear 136 meshes with the second gear 134. The first intersection line 158 defines a first intersection angle 162 with the axis of rotation 152 (and the radial direction R for the embodiment depicted, as the axis of rotation 152 is parallel to the radial direction R) greater than zero (0) degrees and less than 90 degrees, such as greater than fifteen (15) degrees and less than seventy-five (75) degrees, such as greater than thirty (30) degrees and less than sixty (60) degrees, such as about forty-five (45) degrees. Similarly, the second intersection line 160 defines a second intersection angle 164 with the axis of rotation 152 (and the radial direction R for the embodiment depicted, as the axis of rotation 152 is parallel to the radial direction R) substantially equal to the angle 162 defined between the first intersection line 158 and the axis of rotation 152 (e.g., greater than zero (0) degrees and less than 90 degrees, such as greater than fifteen (15) degrees and less than seventy-five (75) degrees, such as greater than thirty (30) degrees and less than sixty (60) degrees, such as about forty-five (45) degrees). Such a configuration may assist with maintaining the first plurality of turbine rotor blades 106 and the second plurality of turbine rotor blades 108 constrained along the radial direction R during operation of the gas turbine engine.

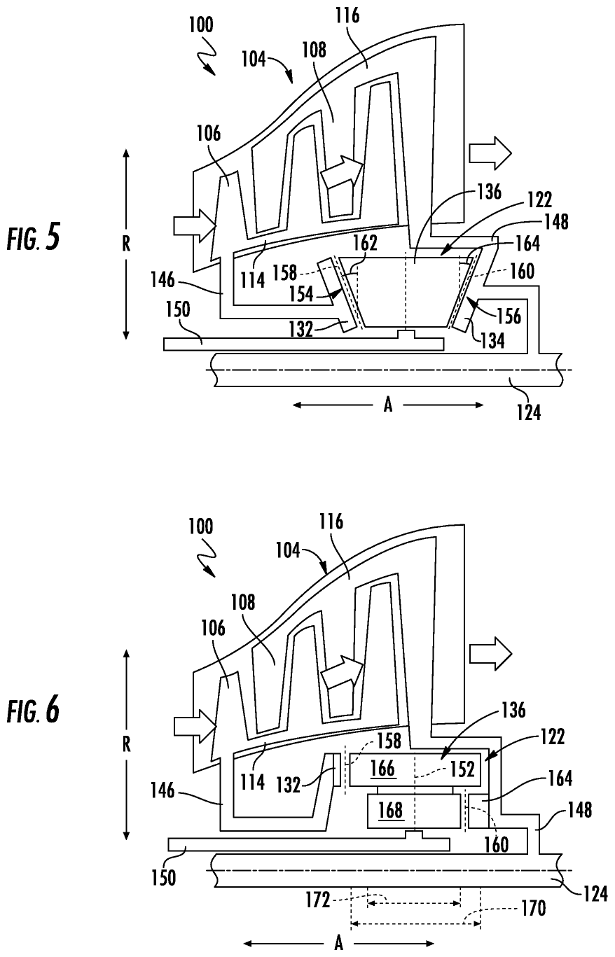

Further, in still other exemplary embodiments, the intermediate gear 136 may have any other suitable configuration. For example, referring now to FIGS. 6 and 7, schematic views of turbines 104 and gearboxes 122 in accordance with other exemplary embodiments of the present disclosure are provided. Referring particularly to FIG. 6, for the embodiment depicted, the intermediate gear 136 is configured as a compound gear, the compound gear including a radially outer gear 166 and a radially inner gear 168 rotatable with one another, and more specifically, fixed to one another. For the embodiment shown, the radially outer gear 166 meshes with the first gear 132 and the radially inner gear 168 meshes with the second gear 134. The radially outer gear 166 defines a first diameter 170 and the radially inner gear 168 defines a second diameter 172. Varying the first diameter 170 and the second diameter 172 may allow for varying a gear ratio between the first plurality of turbine rotor blades 106 and the second plurality of turbine rotor blades 108. For the embodiment shown, the first diameter 170 is greater than the second diameter 172, such that the first plurality of turbine rotor blades 106 may rotate more quickly than the second plurality of turbine rotor blades 108. Notably, however, in other embodiments, such as the exemplary embodiment of FIG. 7, the second diameter 172 may be greater than the first diameter 170, such that the second plurality of turbine rotor blades 108 may rotate more quickly than the first plurality of turbine rotor blades 106.

Further, still, in other embodiments, the gearbox 122 may have still other configurations. For example, referring now to FIG. 8, providing an schematic view of a turbine 104 and gearbox 122 in accordance with yet another exemplary embodiment of the present disclosure, it will be appreciated that the intermediate gear 136 is tilted, such that an angle 174 the axis of rotation 152 defines with the radial direction R is not equal to zero (0). For example, for the embodiment shown, the angle 174 of the axis of rotation 152 defines with the radial direction R may be less than about seventy-five (75) degrees, such as less than about thirty (30) degrees, such as greater than about ten (10) degrees. Notably, although the intermediate gear 136 is depicted as being tilted forward in the embodiment of FIG. 8, in other exemplary embodiments the intermediate gear 136 may alternatively be tilted aft.

Moreover, as with the embodiment of, e.g., FIG. 5, described above, the intermediate gear 136 defines a first intersection line 158 where the intermediate gear 136 meshes with first gear 132, and a second intersection line 160 meshes with the second gear 134. The first intersection line 158 defines an angle 174 with the axis of rotation 152 greater than zero (0) degrees and less than about ninety (90) degrees, such as greater than about fifteen (15) degrees and less than about seventy-five (75) degrees, and similarly the second intersection line 160 defines an angle 174 with the axis of rotation 152 substantially equal to the angle 174 defined between the first intersection line 158 and the axis of rotation 152. However, since the axis of rotation 152 is not parallel to the radial direction R, a first intersection angle 162 defined between the first intersection line 158 and the radial direction R is not equal to a second intersection angle 164 defined between the second intersection line 160 and the radial direction R.

It will be appreciated that by tilting the intermediate gear 136, the gearbox 122 may effectively change a gear ratio between the first gear 132 and second gear 134, and more specifically, between the first plurality of turbine rotor blades 106 and the second plurality. For example, for the embodiment shown, the second plurality of turbine rotor blades 108 may be configured to rotate more quickly than the first plurality of turbine rotor blades 106. However, in other embodiments, the configuration may be switched, such that the first plurality of turbine rotor blades 106 is configured to rotate more quickly the second plurality of turbine rotor blades 108.

It will further be appreciated that in other exemplary embodiments, aspects of the present disclosure may be incorporated into any other suitable gas turbine engine. For example, although the disclosure herein refers to a gearbox within a turbine, in other exemplary embodiments, the gearbox may be positioned within a compressor. With such an exemplary embodiment, the first plurality of rotor blades may instead be a first plurality of compressor rotor blades, and the second plurality of rotor blades may instead be a second plurality of compressor rotor blades. Other configurations are contemplated as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine engine defining a radial direction and an axial direction, the gas turbine engine comprising:
a stationary frame;
a compressor and a turbine, the compressor or the turbine comprising a first plurality of rotor blades and a second plurality of rotor blades, the first plurality of rotor blades and second plurality of rotor blades alternatingly spaced along the axial direction and rotatable with one another; and
a gearbox comprising a first gear coupled to the first plurality of rotor blades, a second gear coupled to the second plurality of rotor blades, and an intermediate gear positioned between the first gear and the second gear and coupled to the stationary frame, the intermediate gear defining an axis of rotation, the axis of rotation defining an angle with the radial direction less than about 75 degrees.

2. The gas turbine engine of claim 1, wherein the angle the axis of rotation defines with the radial direction is less than about 30 degrees.

3. The gas turbine engine of claim 1, wherein the angle the axis of rotation defines with the radial direction is less than about 15 degrees.

4. The gas turbine engine of claim 1, wherein the angle the axis of rotation defines with the radial direction is about zero degrees.

5. The gas turbine engine of claim 1, wherein the intermediate gear is a first intermediate gear of a plurality of intermediate gears spaced along a circumferential direction of the gas turbine engine within the gearbox.

6. The gas turbine engine of claim 1, wherein the intermediate gear defines a forward end and an aft end, wherein the first gear meshes with the intermediate gear at the forward end and wherein the second gear meshes with the intermediate gear at the aft end.

7. The gas turbine engine of claim 6, wherein the first gear and the intermediate gear together define a first intersection line, wherein the second gear and the intermediate gear together define a second intersection line, wherein the first intersection line defines a first intersection angle less than about 75 degrees with the radial direction, and wherein the second intersection line defines a second intersection angle less than about 75 degrees with the radial direction.

8. The gas turbine engine of claim 7, wherein the first intersection angle is less than about 30 degrees with the radial direction, and wherein the second intersection angle is less than about 30 degrees with the radial direction.

9. The gas turbine engine of claim 7, wherein the first intersection angle, the second intersection angle, and the angle the axis of rotation defines with the radial direction are each equal to about zero degrees.

10. The gas turbine engine of claim 7, wherein the first intersection angle and the second intersection angle are each greater than the angle the axis of rotation defines with the radial direction.

11. The gas turbine engine of claim 1, wherein the turbine includes the first plurality of rotor blades and the second plurality of rotor blades, and wherein the stationary frame is a turbine frame.

12. The gas turbine engine of claim 9, wherein the turbine is a low pressure turbine.

13. The gas turbine engine of claim 1, wherein the gas turbine engine in an aeronautical gas turbine engine.

14. The gas turbine engine of claim 1, wherein the intermediate gear is a compound gear comprising an outer gear and an inner gear rotatable with one another, wherein one of the first gear or second gear meshes with the outer gear of the intermediate gear, and wherein the other of the first gear or second gear meshes with the inner gear of the intermediate gear.

15. The gas turbine engine of claim 14, wherein the outer gear defines a first diameter, wherein the inner gear defines an second diameter, wherein the first diameter is not equal to the second diameter.

16. A gearbox for a gas turbine engine defining a radial direction and an axial direction, the gas turbine engine including a stationary frame, a compressor, and a turbine, the compressor or the turbine comprising a first plurality of rotor blades and a second plurality of rotor blades alternatingly spaced, the gearbox comprising
a first gear configured to be coupled to the first plurality of rotor blades of the gas turbine engine;
a second gear configured to be coupled to the second plurality of rotor blades of the gas turbine engine; and
an intermediate gear configured to be coupled to the stationary frame of the gas turbine engine, the intermediate gear defining a forward end and an aft end, the first gear meshing with the intermediate gear at the forward end, the second gear meshing with the intermediate gear at the aft end.

17. The gearbox of claim 16, wherein the intermediate gear further defines an axis of rotation defining an angle with the radial direction less than about 75 degrees.

18. The gearbox of claim 17, wherein the angle the axis of rotation defines with the radial direction is less than about 15 degrees

19. The gearbox of claim 16, wherein the first gear and the intermediate gear together define a first intersection line, wherein the second gear and the intermediate gear together define a second intersection line, wherein the first intersection line defines a first intersection angle less than about 75 degrees with the radial direction, and wherein the second intersection line defines a second intersection angle less than about 75 degrees with the radial direction

20. The gearbox of claim 16, wherein the intermediate gear is a compound gear comprising an outer gear and an inner gear rotatable with one another, wherein one of the first gear or second gear meshes with the outer gear of the intermediate gear, and wherein the other of the first gear or second gear meshes with the inner gear of the intermediate gear.
